(19) United States
(12) Patent Application Publication
(10) Pub. No.: US 2017/0114471 A1
(43) Pub. Date: Apr. 27, 2017

(54) VALVE ASSEMBLY WITH WEAR- AND OXIDATION-RESISTANT COATING

(71) Applicant: HONEYWELL INTERNATIONAL INC., Morris Plains, NJ (US)

(72) Inventors: Derek Anthony Rice, Phoenix, AZ (US); Amer Aizaz, Phoenix, AZ (US); James Piascik, Randolph, NJ (US)

(73) Assignee: HONEYWELL INTERNATIONAL INC., Morris Plains, NJ (US)

(21) Appl. No.: 14/923,744

(22) Filed: Oct. 27, 2015

(51) Int. Cl. C25D 11/02; F01D 17/14; C25D 11/06; C25D 5/48; C25D 11/16

(52) U.S. Cl. CPC C25D 11/026; C25D 5/48; C25D 11/16; C25D 11/06; F01D 17/145; F05D 2220/32; F05D 2300/175; F05D 2230/314; F05D 2230/60

(57) ABSTRACT

A method for manufacturing a valve assembly includes the steps of: providing one or more nickel-based superalloy components of the valve assembly, wherein the one or more components are designed to be subjected to operating environments including temperatures of about 760° C., +/−about 30° C.; aluminizing the one or more components using an aluminizing process, wherein the aluminizing process causes inter-diffusion between the nickel-based superalloy and aluminum as well as forms an aluminum-rich surface layer on the one or more components, thereby forming one or more aluminized components; and subjecting the one or more aluminized components to a plasma electrolytic oxidation process to convert the aluminum rich surface layer into a hard, wear-resistant, and oxidation-resistant aluminum oxide coating layer, wherein the hardness, wear-resistance, and oxidation-resistance of the aluminum oxide coating layer is maintained in the operating environments including temperatures of about 760° C., +/−about 30° C.

### TECHNICAL FIELD

The present disclosure relates to valve assemblies for use in high temperature environments, such as gas turbine engines. The disclosed valve assemblies include a coating for wear resistance and oxidation resistance in these high temperature environments.

### BACKGROUND

Valves may be employed in any one of numerous situations. For example, valves may be used in an air distribution system to direct airflow from one portion of a gas turbine engine (for example of an aircraft, APU, helicopter, tank, etc.) to another. In this regard, pneumatic valves may be disposed in a duct between an air source and one or more outlets for exhausting the received air to desired areas within the gas turbine engine, such as, for example, from one or more compressor sections of the engine.

One exemplary type of pneumatic valve that has been employed in aircraft is a butterfly valve. A butterfly valve is typically made up of a valve flowbody and a butterfly plate. The valve flowbody may be made of a rigid material, such as metal, and includes an inner surface defining a channel. The valve flowbody is configured to be disposed between two ducts or disposed in a portion of a single duct. The butterfly plate is made of a rigid material as well and is rotationally mounted to the valve flowbody. Conventionally, the butterfly plate is positioned in the channel such that a minimum clearance is formed with the inner surface of the valve flowbody. An actuator and a spring may be used to control the rotation of the butterfly plate.

Typically, the butterfly plate is moved between closed, open, and partially open positions. When in the closed position, the butterfly plate substantially blocks the channel to prevent, or at least inhibit, fluid from flowing therethrough. When fluid flows through the valve flowbody in a forward direction, the butterfly plate moves to the open or partially open position to allow fluid flow through the channel. An actuator is typically used as a control device to mechanically cause the disk of a butterfly valve to rotate. Actuators can be either manual or automatic and operated by hand, electronics, pneumatics, hydraulics, or springs.

Typical gas turbine engine valves are manufactured using a superalloy material, such as a nickel-based superalloy, due to this material's ability to withstand somewhat elevated operating temperatures. Even using these superalloy materials, though, some currently-known valve designs suitable for use in aircraft are limited to service conditions where the temperatures are below about 1200° F. (about 650° C.), because above such temperatures, the valves become susceptible to oxidation and wear damage. However, next-generation gas turbine engines, which operate at higher temperatures for purposes of efficiency, will require the use of valves that are able to withstand service conditions where the temperatures are at about 1400° F. +/−50° F. (about 760° C. +/−30° C.).

Accordingly, there is a need in the art for gas turbine engine valve assemblies that are suitable for use in operating environments where temperatures are at or about 760° C. Furthermore, other desirable features and characteristics of the inventive subject matter will become apparent from the subsequent detailed description and the appended claims, taken in conjunction with the accompanying drawings and the foregoing technical field and background.

### BRIEF SUMMARY

In one exemplary embodiment, a method for manufacturing a valve assembly includes the steps of: providing one or more nickel-based superalloy components of the valve assembly, wherein the one or more components are designed to be subjected to operating environments including temperatures of about 760° C., +/−about 30° C.; aluminizing the one or more components using an aluminizing process, wherein the aluminizing process causes inter-diffusion between the nickel-based superalloy and aluminum as well as forms an aluminum-rich surface layer on the one or more components, thereby forming one or more aluminized components; and subjecting the one or more aluminized components to a plasma electrolytic oxidation process to convert the aluminum rich surface layer into a hard, wear-resistant, and oxidation-resistant aluminum oxide coating layer, wherein the hardness, wear-resistance, and oxidation-resistance of the aluminum oxide coating layer is maintained in the operating environments including temperatures of about 760° C., +/−about 30° C.

In another exemplary embodiment, a method for using a valve assembly includes the steps of: providing the valve assembly, wherein the valve assembly is formed using process steps including: a) providing one or more nickel-based superalloy components of the valve assembly, wherein the one or more components are designed to be subjected to operating environments including temperatures of about 760° C., +/−about 30° C.; b) aluminizing the one or more components using an aluminizing process, wherein the aluminizing process causes inter-diffusion between the nickel-based superalloy and aluminum as well as forms an aluminum-rich surface layer on the one or more components, thereby forming one or more aluminized components; c) subjecting the one or more aluminized components to a plasma electrolytic oxidation process to convert the aluminum rich surface layer into a hard, wear-resistant, and oxidation-resistant aluminum oxide coating layer, wherein the hardness, wear-resistance, and oxidation-resistance of the aluminum oxide coating layer is maintained in the operating environments including temperatures of about 760° C., +/−about 30° C.; and d) assembling the one or more components into a completed valve assembly subsequent to performing the plasma electrolytic oxidation process; The method of use further includes the steps of installing the completed valve assembly into a gas turbine engine and operating the gas turbine engine so as to expose the one or more components of the completed valve assembly to temperatures of about 760° C., +/−about 30° C.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

At least one example of the present invention will hereinafter be described in conjunction with the following figures, wherein like numerals denote like elements, and wherein:

FIG. 1 is a cross-sectional view of a valve assembly that may be implemented into a gas turbine engine, according to an embodiment;

FIG. 2 is a process flow diagram illustrating a method for manufacturing a valve assembly, according to an embodiment; and

FIG. 3 is a process flow diagram illustrating a method of use of a valve assembly, according to an embodiment.

### DETAILED DESCRIPTION OF A PREFERRED EMBODIMENT

The following detailed description of the inventive subject matter is merely exemplary in nature and is not intended to limit the inventive subject matter or the application and uses of the inventive subject matter. Furthermore, there is no intention to be bound by any theory presented in the preceding background of the inventive subject matter or the following detailed description of the inventive subject matter.

As initially noted above, some current gas turbine engine valve designs are limited to service conditions of less than about 650° C. because at higher temperatures, the materials require coatings resistant to both wear and oxidation. Pneumatic vales operating at about 760° C. need both a valve bore coating and tribological wear resistant coating on wear surfaces to meet design performance requirements, which include operating lives of about 10,000 hours in an oxidizing environment, as well as resistance to both fretting and sliding wear.

The present disclosure solves the problems of 1) oxidation at about 760° C. and 2) wear resistance at about 760° C. by utilizing a process referred to as plasma electrolytic oxidation (PEO) coating to create a thick wear and oxidation resistant coating on valve components exposed to the harsh operating environment. The present disclosure utilizes a nickel-based superalloy valve body and components (e.g., butterfly plate) coated with a thick (e.g., about 0.0005 inch to about 0.0025 inch (about 13 microns to about 64 microns)) alumina oxide fabricated by an aluminizing process and subsequently the PEO process to convert the aluminum rich surface layer to a hard, wear-resistant coating. Adding the PEO process step to convert the aluminum rich layer to a hard abrasion resistant alumina surface has been found to provide the valve components with the unique tribological wear, abrasion, and impact resistant properties needed by high-temperature pneumatic valve applications.

### Valve Assembly Design

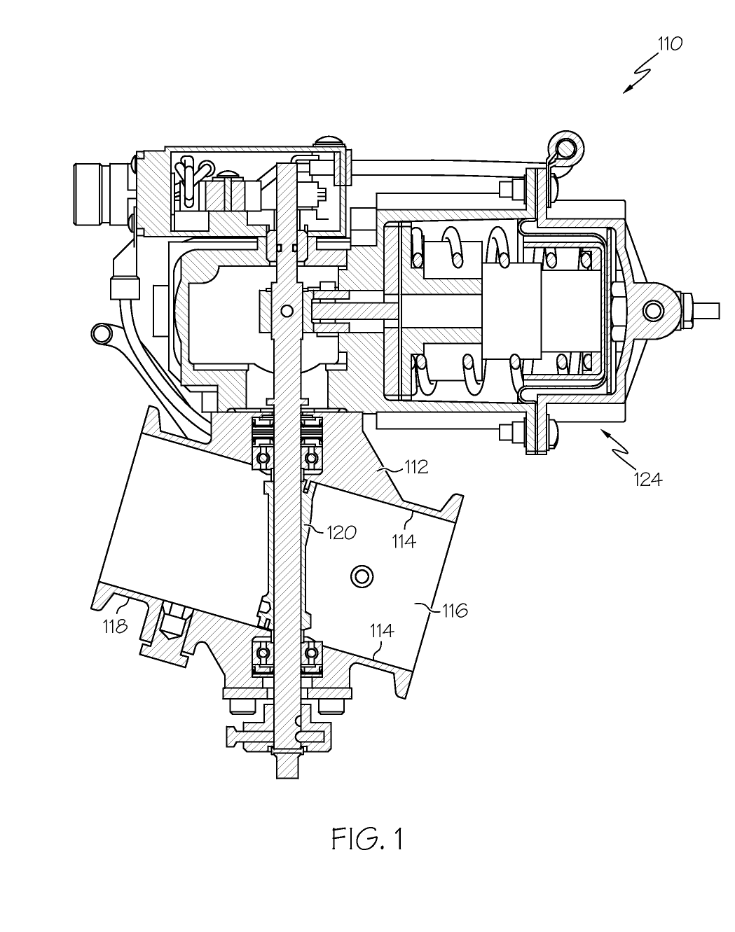

The particular design or configuration of the valve assembly is not a critical feature of this disclosure. Rather, the processes disclosed below should be applicable to any number of valve designs that are used now or in the future in high-temperature applications, such as in gas turbine engines. While an exemplary valve design is disclosed herein as FIG. 1 for purposes of completeness, it should be expected that the skilled artisan will be able to extend the teachings presented below to any other suitable valve design.

FIG. 1 is a cross-sectional view of a valve assembly 110 that may be implemented into a gas turbine engine for operation at about 760° C., +/−about 30° C., according to an embodiment. The valve assembly 110 includes a valve flowbody 112 having an inner surface 114 that defines a channel 116 and an outer surface 118. The valve flowbody 112 is generally made of a metallic material. The metallic material is typically a nickel-based superalloy. Although one channel 116 is shown formed in the valve flowbody 112, it will be appreciated that more may alternatively be incorporated. In an embodiment, the valve flowbody 112 may be surrounded by an insulator 113. A butterfly plate 120 is disposed in the channel 116 and is rotationally mounted to the valve flowbody 112. The butterfly plate 120 may be coupled to an actuator 124 that causes it to selectively open or close. The actuator 124 may be any actuating mechanism, including, but not limited to, an electric actuator, a pneumatic actuator, a hydraulic actuator, or a manual actuator.

Various components of the valve assembly 110 are coated with an oxidation- and wear-resistant coating, as will be described in greater detail below. Examples of the coated components may be the valve flow body 112 and/or the butterfly plate 120. It should be understood that the coated components of the valve assembly 110 are those expected to encounter wear and/or oxidation. While the valve flow body 112 and the butterfly plate 120 are listed as examples of such components according to the valve design of FIG. 1, it should be appreciated that the skilled artisan will be able to identify the components of other valve designs that require the coating. Further, it should be understood that the valve components suitable for use in this coating process are those that require no further forming/machining/shaping subsequent to being subjected to the coating process. That is, once coated, these parts should be ready for assembly into the valve assembly.

### Aluminizing Process

Application of the coating to the selected nickel-based superalloy valve components begins with an aluminizing process, where a layer of aluminum is applied to the surface of the valve components. The aluminizing process may be selected as one that achieves some diffusion of the aluminum into the nickel-based superalloy in order to ensure a good bond between the coating and the superalloy, yet still leaves an aluminum rich surface layer that can be converted to a ceramic using the PEO process, as described below. Suitable aluminizing processes according to these characteristics include chemical vapor deposition (CVD), pack cementation, electroplating, and slurry coating, among others, each of which are discussed briefly below for purposes of completeness, although it is expected that the skilled artisan is aware of the details of these aluminizing processes. Regardless of how formed, the aluminum layer formed on the superalloy substrate by the aluminizing process may be from about 0.0005 inch to about 0.0025 inch (about 13 microns to about 64 microns).

The CVD method includes, in some embodiments, transferring aluminum from solid (e.g. mixture of aluminum granules or aluminum powders and Al₂O₃—of different proportions) to its active compounds (precursors), i.e. halides AlCl₃ in a gaseous phase, which form in external generator and then transport it using gas carrier (H₂) to the main retort (reactor chamber) to develop the coating at high temperature and at low pressure (LP CVD—low pressure chemical vapor deposition). In the low-activity CVD process the aluminum halides (AlCl₃) are converted as a result of pyrolysis reaction to the sub-halides, next they are deposited on the substrate and then react exothermically with substrate (Ni-based superalloy). Different thickness of the layers formed in the low-activity CVD process may be obtained. Many factors affect the kinetics of the coatings growth, for example temperature in the main reactor, value of the flow rate of HCl and AlCl₃ and also of the carrier gasses (and their suitable proportions). The diffusion aluminide coatings produced in low-activity process by use of the LP CVD method normally consist of the outer (additive) layer and diffusion zone.

The pack cementation method includes, in some embodiments, immersing the nickel-based superalloy components in a powder mixture containing Al₂O₃ and aluminum particles. About 1 to about 2 wt-% of ammonium halide activators are added to this pack. This is then heated about 800 to about 1000° C. in argon or H₂ atmosphere. At these temperatures, aluminum halides form, which diffuse through the pack and react on the substrate to deposit Al metal. Variables that affect the coating process include: substrate composition, powder bed composition, heat treating conditions, time, and furnace atmosphere.

The electroplating method includes, in some embodiments, applying aluminum or an aluminum alloy to at least one surface of the superalloy component by electroplating in an ionic liquid aluminum plating bath or in a solvent bath to form a plated component, the ionic liquid aluminum plating bath including an ionic liquid having a melting point less than 100° C. and an aluminum salt. The plated component is heat treated at a first temperature of about 600° C. to about 650° C. for about 15 to about 45 minutes and then further heat treated at a second temperature of about 700° C. to about 1050° C. for about 0.50 hours to about two hours or a second temperature of about 750° C. to about 900° C. for about 12 to about 20 hours. Further details regarding this process may be found in commonly-assigned U.S. Pat. No. 8,778,164 B2.

The slurry coating method includes, in some embodiments, applying as a slurry an aluminum or aluminum alloy to at least one surface of the superalloy component. Then, the slurry is diffused in a controlled environment furnace into the superalloy component.

Optionally, in addition to forming the above-noted diffusion layer of aluminum into the nickel-based superalloy component, it may be desirable to form an aluminum layer on the surface of the diffusion layer. Forming this optional, additional aluminum layer may be performed using conventional aluminum deposition methods as are known in the art, such as CVD, electroplating, etc.

### Plasma Electrolytic Oxidation Process

The PEO process is performed on the aluminized valve components to transform the aluminum-rich surface layer of these components into a hard and durable aluminum oxide ceramic material, which will allow the valve assemblies to be used in gas turbine engine operating environments including temperatures of about 760° C., +/−about 30° C. The PEO process is an electrochemical surface treatment process for generating oxide coatings on metals. It is similar to anodizing, but it employs higher potentials, so that discharges occur and the resulting plasma modifies the structure of the oxide layer. This process can be used to grow thick (tens or hundreds of micrometers), largely crystalline, oxide coatings on metals such as aluminum. Because they can present high hardness and a continuous barrier, these coatings can offer protection against wear, corrosion, oxidation, and/or heat.

The PEO coating process is a chemical conversion of the metal into its oxide, and grows both inwards and outwards from the original metal surface. Because it is a conversion coating, rather than a deposited coating (such as a coating formed by plasma spraying), it has excellent adhesion to the substrate metal. In plasma electrolytic oxidation, high potentials are applied. For example, in the plasma electrolytic oxidation of aluminum, at least 200 V must be applied. This locally exceeds the dielectric breakdown potential of the growing oxide film, and discharges occur. These discharges result in localized plasma reactions, with conditions of high temperature and pressure which modify the growing oxide. Processes include melting, melt-flow, re-solidification, sintering, and densification of the growing oxide.

In practice, the component to be subjected to the PEO process is immersed in a bath of electrolyte which usually includes a dilute alkaline solution such as KOH. It is electrically connected, so as to become one of the electrodes in the electrochemical cell, with the other “counter-electrode” typically being made from an inert material such as stainless steel, and often including of the wall of the bath itself. Potentials of over 200 V are applied between these two electrodes. These may be continuous or pulsed direct current (DC) (in which case the part is simply an anode in DC operation), or alternating pulses (alternating current or “pulsed bi-polar” operation) where the stainless steel counter electrode might just be grounded.

After the PEO process is complete, the component includes a thick layer (about 13 microns to about 64 microns) of a hard, wear-resistant aluminum oxide coating formed thereon. Each coated component of the valve assembly 110, such as the valve flow body 112 and/or the butterfly plate 120, as well as other non-coated components, are then assembled to form the completed valve assembly 110. This completed valve assembly will be suitable for use in oxidizing environments of a gas turbine engine at temperatures of about 760° C., +/−about 30° C., and will exhibit tribological wear resistance.

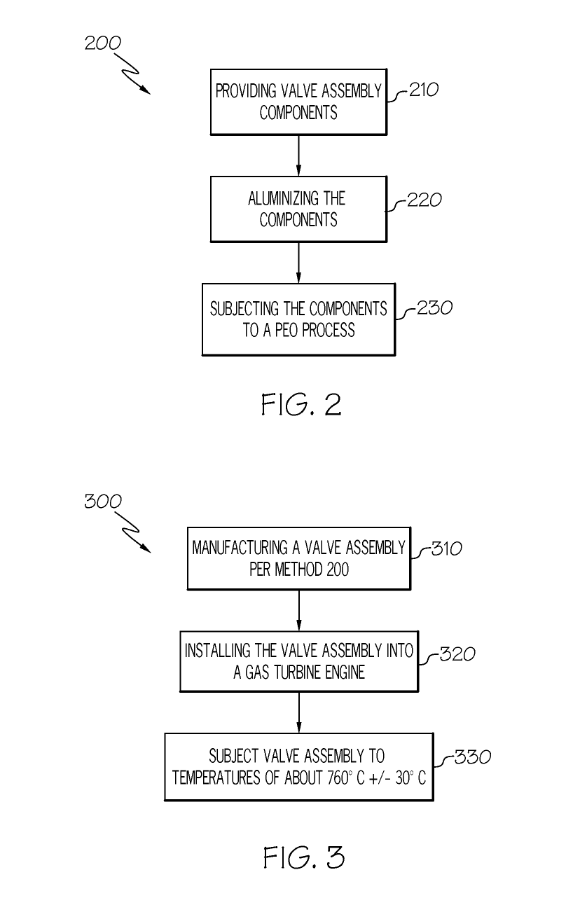

The method for manufacturing the valve assembly may thus be summarized as shown in FIG. 2, method 200. Method 200 begins with a step 210 of providing nickel-based superalloy valve assembly components to be coated, such as valve flow bodies and butterfly plates. Method 200 then proceeds to step 220, which includes aluminizing the components. The step 220 may be conducted using an aluminizing method that causes some inter-diffusion between the aluminum and the superalloy to ensure a good coating bond, as well as provides an aluminum-rich surface layer for subsequent conversion to the ceramic. Thereafter, the method 200 includes a step 230 of performing a PEO process on the aluminized component. The PEO process converts the aluminum-rich surface layer to a hard, durable aluminum oxide coating capable of withstanding oxidation and tribological wear in operating environments where the temperatures reach about 760° C., +/−about 30° C.

Furthermore, a method of use of such a valve assembly may be summarized as shown in FIG. 3, method 300. Method 300 begins with the step 310 of manufacturing a valve assembly according to the method 200. Method 300 continues with a step 320 of installing the valve assembly into a gas turbine engine (for example of an aircraft, APU, helicopter, tank, etc.), such as surrounding or connected to one of the compressor sections thereof. Method 300 thereafter concludes with a step 330 of operating the gas turbine engine and subjecting the coated portions of the valve assembly to temperatures of about 760° C., +/−about 30° C.

While the inventive subject matter has been described with reference to a preferred embodiment, it will be understood by those skilled in the art that various changes may be made and equivalents may be substituted for elements thereof without departing from the scope of the inventive subject matter. In addition, many modifications may be made to adapt to a particular situation or material to the teachings of the inventive subject matter without departing from the essential scope thereof. Therefore, it is intended that the inventive subject matter not be limited to the particular embodiment disclosed as the best mode contemplated for carrying out this inventive subject matter, but that the inventive subject matter will include all embodiments falling within the scope of the appended claims.

What is claimed is:

1. A method for manufacturing a valve assembly comprising the steps of:
providing one or more nickel-based superalloy components of the valve assembly, wherein the one or more components are designed to be subjected to operating environments including temperatures of about 760° C., +/−about 30° C.;
aluminizing the one or more components using an aluminizing process, wherein the aluminizing process causes inter-diffusion between the nickel-based superalloy and aluminum as well as forms an aluminum-rich surface layer on the one or more components, thereby forming one or more aluminized components; and
subjecting the one or more aluminized components to a plasma electrolytic oxidation process to convert the aluminum rich surface layer into a hard, wear-resistant, and oxidation-resistant aluminum oxide coating layer, wherein the hardness, wear-resistance, and oxidation-resistance of the aluminum oxide coating layer is maintained in the operating environments including temperatures of about 760° C., +/−about 30° C.

2. The method of claim 1, wherein providing the one or more components comprises providing one or more components of a gas turbine engine pneumatic valve assembly.

3. The method of claim 2, wherein providing the one or more components comprises providing a valve flow body.

4. The method of claim 2, wherein providing the one or more components comprises providing a valve butterfly plate.

5. The method of claim 1, wherein the step of aluminizing comprises aluminizing using a chemical vapor deposition process.

6. The method of claim 1, wherein the step of aluminizing comprises aluminizing using a pack cementation process.

7. The method of claim 1, wherein the step of aluminizing comprises aluminizing using an electroplating process.

8. The method of claim 1, wherein the step of aluminizing comprises aluminizing using a slurry process.

9. The method of claim 1, further comprising forming an aluminum surface layer over the inter-diffused aluminum/superalloy.

10. The method of claim 1, further comprising assembling the one or more components into a completed valve assembly subsequent to performing the plasma electrolytic oxidation process.

11. The method of claim 1, wherein the method excludes steps of forming, machining, and shaping of the one or more components subsequent to performing the plasma electrolytic oxidation process.

12. The method of claim 1, wherein assembling comprises providing additional components that were not subjected to aluminizing and plasma electrolytic oxidation, and incorporating the additional components with the one or more components to assemble the completed valve assembly.

13. A method for using a valve assembly comprising the steps of:
providing the valve assembly, wherein the valve assembly is formed using process steps comprising:
a) providing one or more nickel-based superalloy components of the valve assembly, wherein the one or more components are designed to be subjected to operating environments including temperatures of about 760° C., +/−about 30° C.;
b) aluminizing the one or more components using an aluminizing process, wherein the aluminizing process causes inter-diffusion between the nickel-based superalloy and aluminum as well as forms an aluminum-rich surface layer on the one or more components, thereby forming one or more aluminized components;
c) subjecting the one or more aluminized components to a plasma electrolytic oxidation process to convert the aluminum rich surface layer into a hard, wear-resistant, and oxidation-resistant aluminum oxide coating layer, wherein the hardness, wear-resistance, and oxidation-resistance of the aluminum oxide coating layer is maintained in the operating environments including temperatures of about 760° C., +/−about 30° C.; and
d) assembling the one or more components into a completed valve assembly subsequent to performing the plasma electrolytic oxidation process;
installing the completed valve assembly into a gas turbine engine; and
operating the gas turbine engine so as to expose the one or more components of the completed valve assembly to temperatures of about 760° C., +/−about 30° C.

14. The method of claim 11, wherein the step of installing comprises installing the completed valve assembly surrounding or connected to a compressor section of the gas turbine engine.
